(19) United States
(12) Patent Application Publication
(10) Pub. No.: US 2015/0209604 A1
(43) Pub. Date: Jul. 30, 2015

(54) FIRE EXTINGUISHER APPARATUS

(71) Applicant: Ching Lun Ma, Taichung City (TW)

(72) Inventor: Ching Lun Ma, Taichung City (TW)

(21) Appl. No.: 14/162,747

(22) Filed: Jan. 24, 2014

(51) Int. Cl. A62C 13/76; A62C 8/00; F21V 33/00; A62C 13/64

(52) U.S. Cl. CPC A62C 13/76; A62C 13/64; A62C 8/00; F21V 33/0064; F21W 2131/30

(57) ABSTRACT

A fire extinguisher apparatus includes a cylinder, an extinguisher head, a lid member and a lighting device. The cylinder has a chamber therein. The extinguisher head is mounted at one end of the cylinder. The extinguisher head has a base and an operating lever. The base has a nozzle communicating with the chamber of the cylinder. The operating lever is configured to control the nozzle. The lid member is provided to cover the base and the operating lever. The lighting device is mounted at the other end of the cylinder. The lighting device has a head and a shank. The head has a light source disposed therein and a striking portion at a front edge thereof. The striking portion of the head is annularly formed with a plurality of protrusions spaced apart in a distance, which is configured to strike window glass in an emergency.

### BACKGROUND OF THE INVENTION

1. Field of the Invention

The present invention relates to a fire extinguisher and more particularly to a fire extinguisher apparatus with lighting device.

2. Description of Related Art

Fire extinguisher is an active fire protection device used to extinguish or control small fires, often in emergency situations.

U.S. Pat. No. 6,641,286 discloses a fire extinguisher mount/locator, which is provided an illuminated mounting system for storing a small, domestic type fire extinguisher in a manner allowing quick location and retrieval in the event of a fire. A rear section of a housing is plugged into a convenient electrical outlet and a fire extinguisher is mounted thereon. In a preferred embodiment, a front section of the housing, containing an illuminating beacon/nightlight and a rechargeable flashlight, hinges closed to secure the fire extinguisher in place. The mount/locator may be used as a flashlight either with or without the fire extinguisher in place. Furthermore, the illuminating beacon/nightlight and the rechargeable flashlight plug into a receptacle in the rear housing allowing use of the flashlight without disturbing the fire extinguisher.

Although the conventional fire extinguisher is combined with a lighting device for illumination, the conventional fire extinguisher cannot be applied to break through window glass in an emergency.

The present invention has arisen to mitigate and/or obviate the disadvantages of the conventional fire extinguisher.

### SUMMARY OF THE INVENTION

The main objective of the present invention is to provide an improved fire extinguisher apparatus.

To achieve the objective, a fire extinguisher apparatus comprises a cylinder, an extinguisher head, a lid member and a lighting device. The cylinder has a chamber defined therein. The extinguisher head is mounted at one end of the cylinder. The extinguisher head has a base and an operating lever. The base has a nozzle communicating with the chamber of the cylinder. The operating lever is pivotally mounted on a top of the base and configured to control the nozzle. The lid member is attached to one end of the cylinder for covering the base and the operating lever of the extinguisher head. The lighting device is mounted at the other end of the cylinder. The lighting device has a head and a shank connecting the head and the cylinder. The head has a light source disposed therein and a striking portion defined at a front edge of the head. The striking portion is annularly formed with a plurality of protrusions spaced apart in a distance, which is configured to strike window glass in an emergency.

Preferably, the base of the extinguisher head defines a through hole for accommodating a locking pin such that the locking pin is inserted into the through hole of the base to lock the operating lever. In addition, the fire extinguisher apparatus further comprises a pressure gauge defined at one side of the base to measure pressure in the chamber of the cylinder. The lid member has an opening corresponding to the pressure gauge so that the pressure gauge is exposed from the lid member as the lid member is placed over the cylinder. Furthermore, the shank of the lighting device has a receiving hole defined at one end thereof. The cylinder has a cavity corresponding to the receiving hole of the shank. The receiving hole of the shank and the cavity of the cylinder define a compartment for accommodating a battery. The shank of the lighting device has a button defined at an outer periphery thereof, which is electrically connected to the battery and the light source to control the light source. The shank of the lighting device has a charging port defined at the outer periphery thereof, which is provided for charging the battery.

Specifically, every adjacent two of the protrusions of the striking portion are spaced apart to define a recess therebetween such that the striking portion of the head is substantially crown-shaped.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a fire extinguisher apparatus of the present invention;

FIG. 2 is an exploded perspective view of the fire extinguisher apparatus of FIG. 1;

FIG. 3 illustrates an operation of the extinguisher head of the fire extinguisher apparatus of the FIG. 1;

FIG. 4 illustrates an operation of the lighting device of the fire extinguisher apparatus of the FIG. 1;

FIG. 5 is a partial perspective view of the fire extinguisher apparatus of FIG. 1 taken from another angle;

FIG. 6 illustrates that the fire extinguisher apparatus is applied to strike window glass;

FIG. 7 illustrates that the fire extinguisher apparatus is used for self-defense; and

FIG. 8 illustrates the shank of the fire extinguisher apparatus applied on a surface thereof with fluorescence materials.

### DETAILED DESCRIPTION OF THE INVENTION

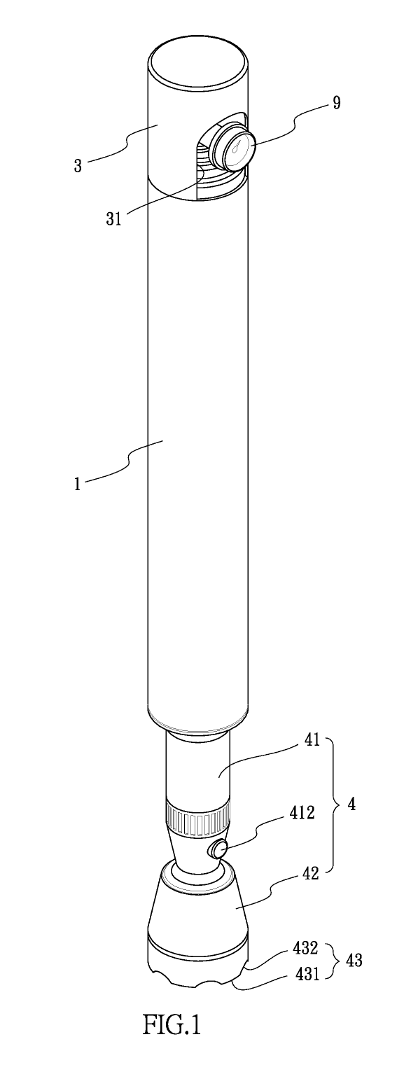

Referring to FIGS. 1-5, a fire extinguisher apparatus in accordance with a preferred embodiment of the present invention comprises a cylinder 1, an extinguisher head 2, a lid member 3 and a lighting device 4. The cylinder 1 has a chamber 11 containing an agent which could be discharged to extinguish fire. The fire extinguishing agents such as water, foam, dry chemical or dry powder.

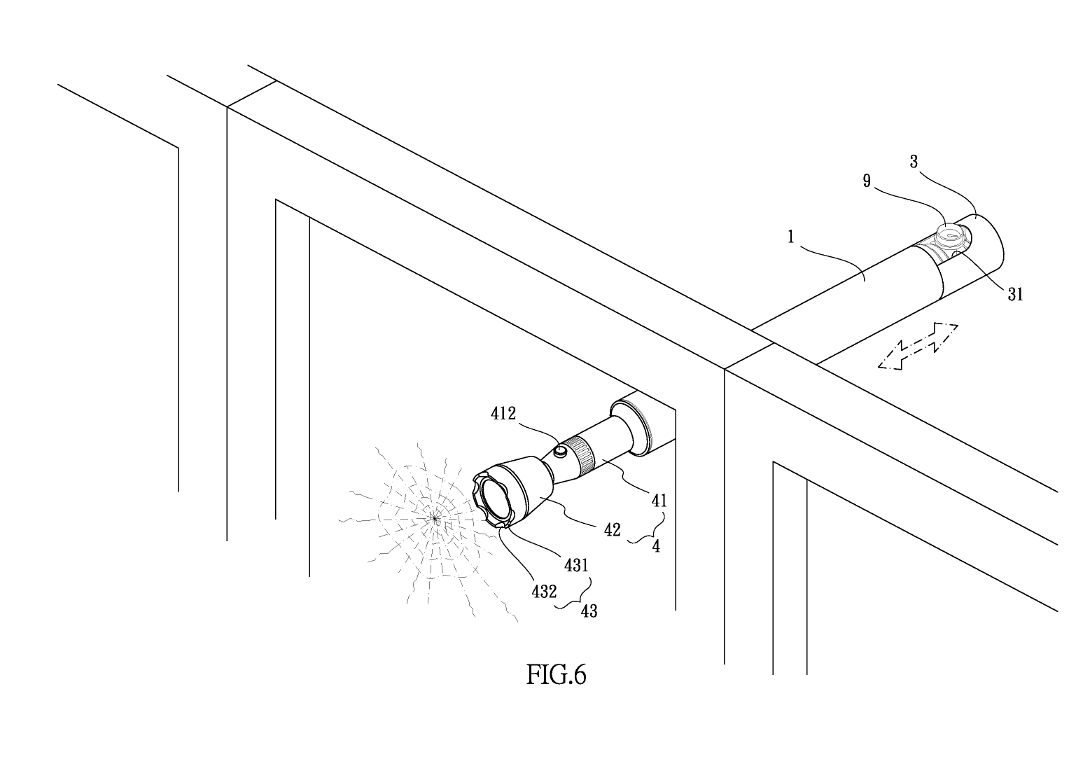

The extinguisher head 2 is mounted at one end of the cylinder 1. The extinguisher head 2 has a base 21 and an operating lever 22. The base 21 has a nozzle 211 communicating with the chamber 11 of the cylinder 1. The operating lever 22 is pivotally mounted on a top of the base 21 and configured to control the nozzle 211. The lid member 3 is attached to one end of the cylinder 1 for covering the base 21 and the operating lever 22 of the extinguisher head 2 so as to protect the extinguisher head 2. The lighting device 4 is mounted at the other end of the cylinder 1. The lighting device 4 has a head 42 and a shank 41 connecting the head 42 and the cylinder 1. Specifically, the head 42 has a light source 6 disposed therein and a striking portion 43 defined at a front edge of the head 42. The striking portion 43 annularly formed with a plurality of protrusions 431 spaced apart in a distance, which is used for striking window glass in an emergency, as depicted in FIG. 6.

Under this arrangement, the fire extinguisher apparatus is combined with extinguisher head 2 and the lighting device 4 with the striking portion 43. Therefore, the fire extinguisher apparatus could be used as a fire extinguisher for extinguishing fire, a flashlight for lighting in conditions of poor visibility and/or an emergency hammer used to break through window glass in an emergency.

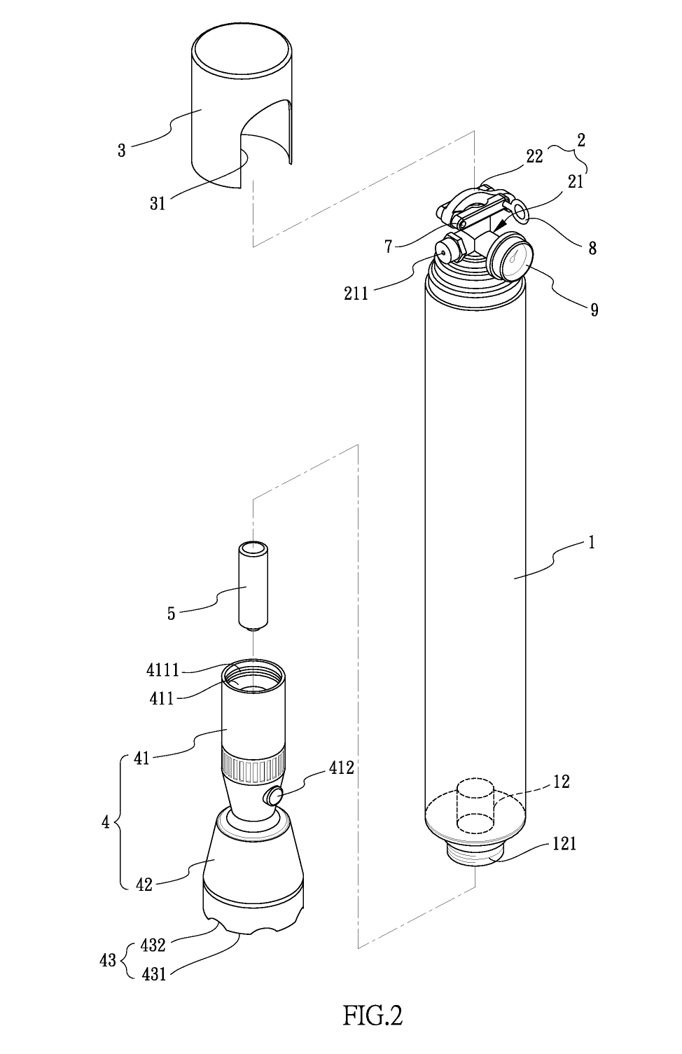

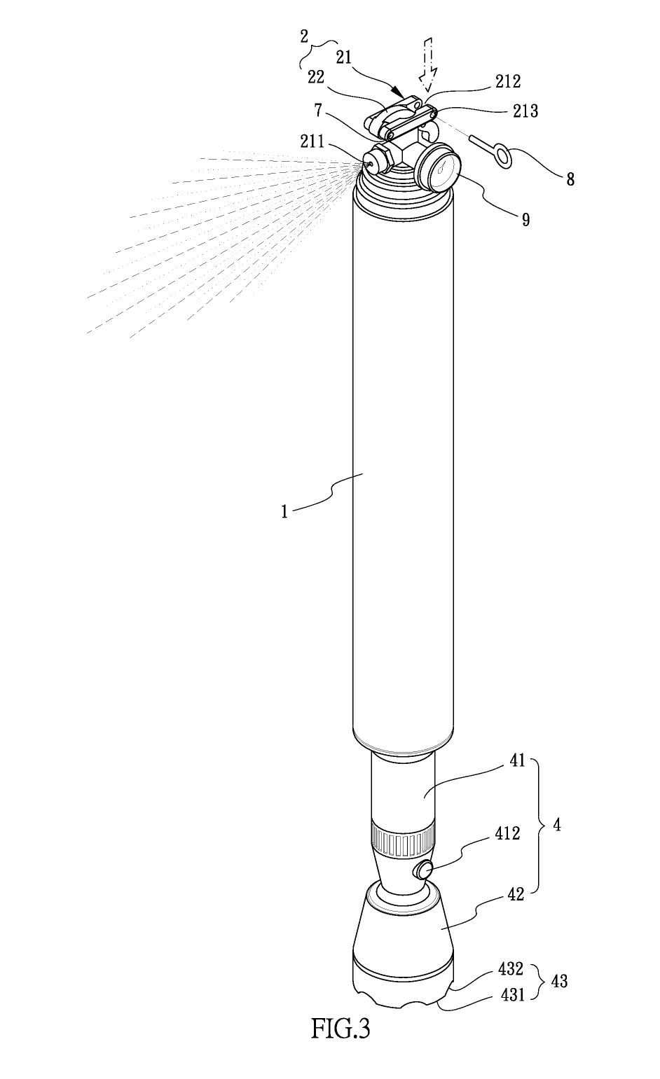

Referring to FIGS. 2-3, the operating lever 22 is pivotally mounted at one end of the base 21 via a pivot shaft 7. The base 21 of the extinguisher head 2 defines a through hole 213 at the other end thereof for accommodating a locking pin 8 such that the locking pin 8 is inserted into the through hole 213 of the base 21 to lock the operating lever 22. In operation, the locking pin 8 should be pulled out at first and then the operating lever 22 could be operated to control the nozzle 21, as depicted in FIG. 3. Furthermore, the base 21 of the extinguisher head 2 defines a gap 212 at the top thereof so that the operating lever 22 is pivotable within the gap 212 of the base 21 for controlling the nozzle 211 of the base 21 to discharge the agent to extinguish fire.

Moreover, the fire extinguisher apparatus further comprises a pressure gauge 9 defined at one side of the base 21 to measure pressure in the chamber 11 of the cylinder 1. Specifically, the lid member 3 has an opening 31 corresponding to the pressure gauge 9 so that the pressure gauge 9 is exposed from the lid member 3 as the lid member 3 is placed over the cylinder 1, as shown in FIGS. 1-2.

Referring to FIG. 2, the shank 41 of the lighting device 4 has a receiving hole 411 defined at one end thereof which is opposite to the head 42 of the lighting device 4. The cylinder 1 has a cavity 12 corresponding to the receiving hole 411 of the shank 41. Therefore, the receiving hole 411 of the shank 41 and the cavity 12 of the cylinder 1 define a compartment for accommodating a battery 5. Specifically, the shank 41 defines an internal thread 4111 in an inner periphery of the receiving hole 411 of the shank 41. The cylinder 1 defines an external thread 121 in an outer periphery of the cavity 12 of the cylinder 1, which corresponds to the internal thread 4111 of the shank 41. Therefore, the lighting device 4 could be connected to the cylinder 1 by means of screwing the external thread 121 of the cylinder 1 to the internal thread 4111 of the shank 41.

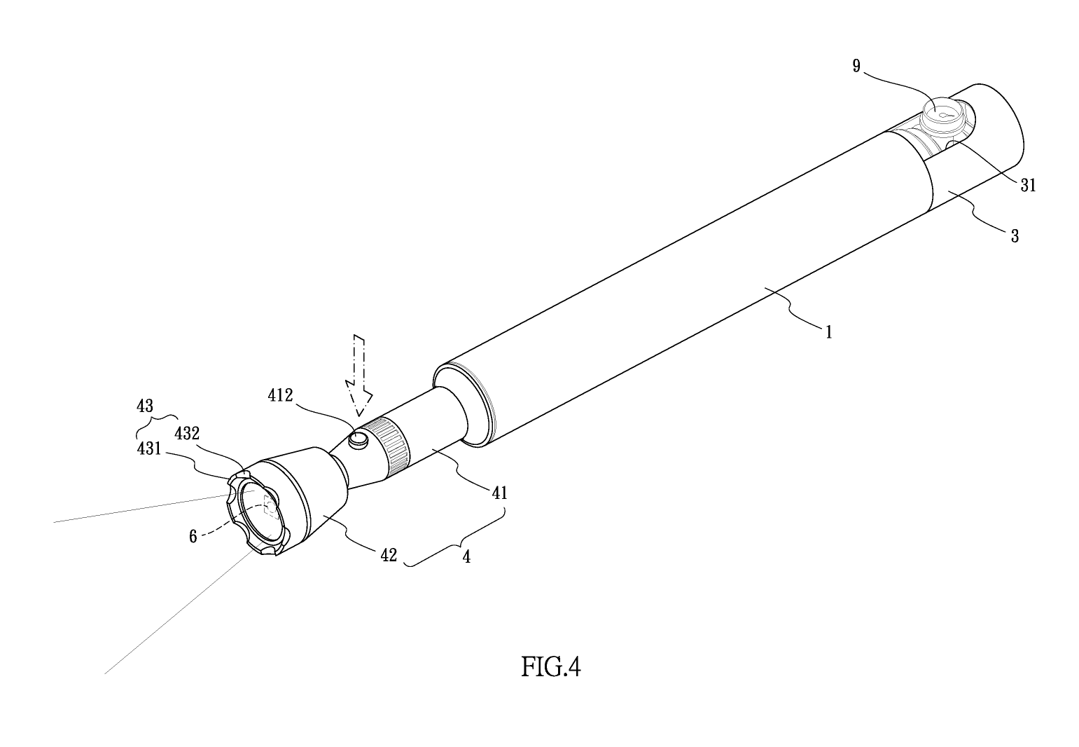

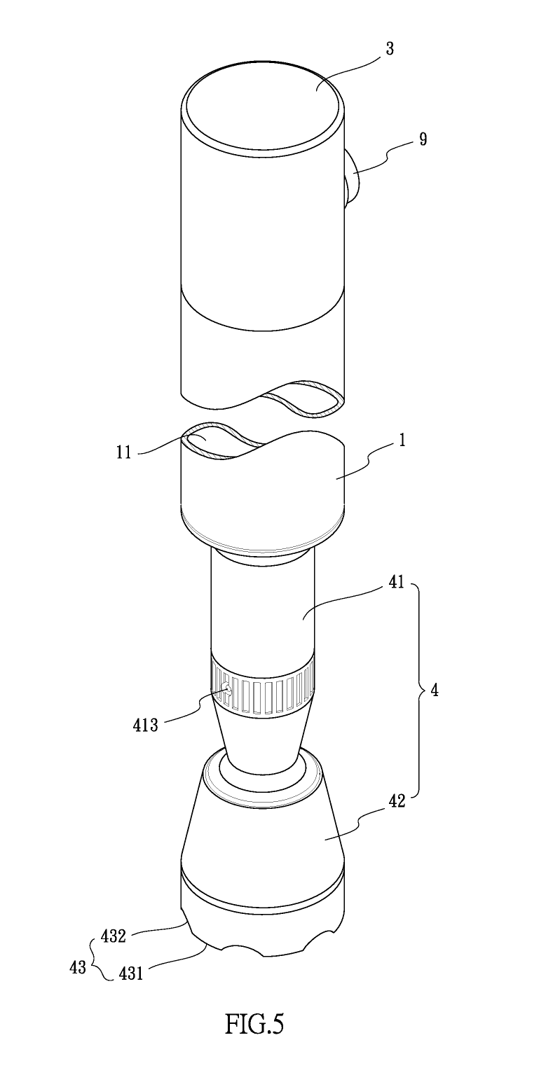

Referring to FIGS. 4-5, the shank 41 of the lighting device 4 has a button 412 defined at an outer periphery thereof. The button 412 is electrically connected to the battery 5 and the light source 6 to control the light source 6. In addition, the shank 41 of the lighting device 4 has a charging port 413 defined at the outer periphery thereof, which is provided for charging the battery 5.

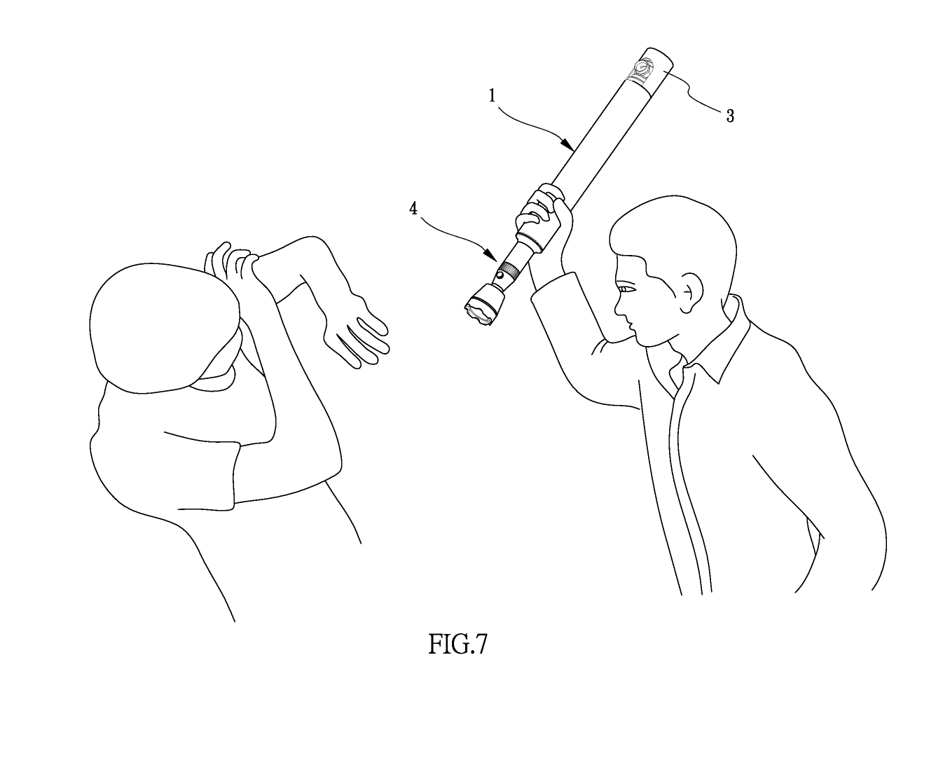

Furthermore, every adjacent two of the protrusions 431 of the striking portion 43 are spaced apart to define a recess 432 therebetween such that the striking portion 43 of the head 42 is substantially crown-shaped so as to break through window glass easily, as shown in FIG. 6. In addition, referring to FIG. 7, the fire extinguisher apparatus could be used as a nightstick for self-defense.

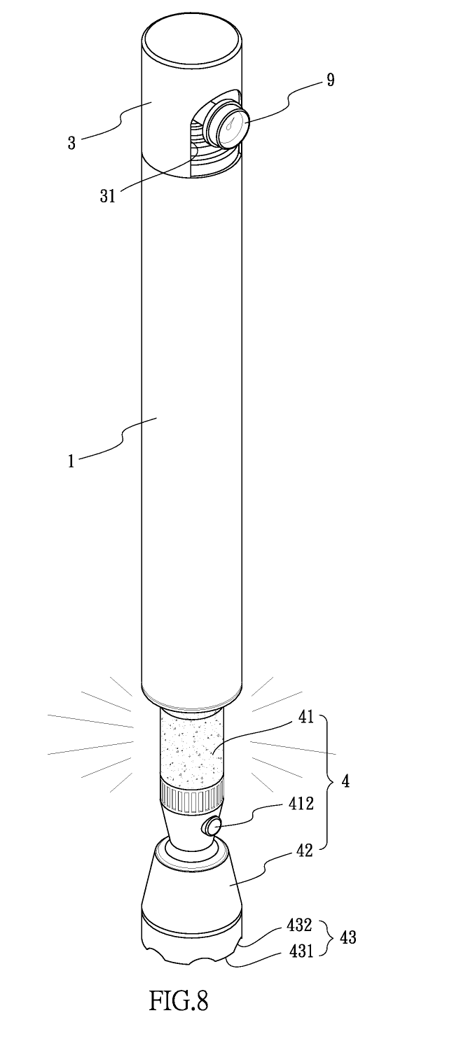

Referring to FIG. 8, the shank 41 of the lighting device 4 is applied on a surface thereof with fluorescence materials, which makes the fire extinguisher apparatus is bright and easy to see, even in the dark. As a result, the fire extinguisher apparatus is a safety device which could be used in a wide range of applications.

Although embodiments of this invention have been fully described with reference to the accompanying drawings, it is to be understood that various modifications can be made by those skilled in the art without departing from the scope of the invention as hereinafter claimed.

What is claimed is:

1. A fire extinguisher apparatus, comprising:
a cylinder having a chamber defined therein;
an extinguisher head mounted at one end of the cylinder, the extinguisher head having a base and an operating lever, the base having a nozzle communicating with the chamber of the cylinder, the operating lever pivotally mounted on a top of the base and configured to control the nozzle;
a lid member attached to one end of the cylinder for covering the base and the operating lever of the extinguisher head; and
a lighting device mounted at the other end of the cylinder, the lighting device having a head and a shank connecting the head and the cylinder, the head having a light source disposed therein and a striking portion defined at a front edge of the head, the striking portion annularly formed with a plurality of protrusions spaced apart in a distance.

2. The fire extinguisher apparatus as claimed in claim 1, wherein the operating lever is pivotally mounted at one end of the base; and the base of the extinguisher head defines a through hole at the other end thereof for accommodating a locking pin such that the locking pin is inserted into the through hole of the base to lock the operating lever.

3. The fire extinguisher apparatus as claimed in claim 2, further comprising a pressure gauge defined at one side of the base to measure pressure in the chamber of the cylinder.

4. The fire extinguisher apparatus as claimed in claim 3, wherein the lid member has an opening corresponding to the pressure gauge so that the pressure gauge is exposed from the lid member as the lid member is placed over the cylinder.

5. The fire extinguisher apparatus as claimed in claim 1, wherein the shank of the lighting device has a receiving hole defined at one end thereof opposite to the head; the cylinder has a cavity corresponding to the receiving hole of the shank; wherein the receiving hole of the shank and the cavity of the cylinder define a compartment for accommodating a battery.

6. The fire extinguisher apparatus as claimed in claim 5, wherein the shank of the lighting device has a button defined at an outer periphery thereof, which is electrically connected to the battery and the light source to control the light source.

7. The fire extinguisher apparatus as claimed in claim 6, wherein the shank of the lighting device has a charging port defined at the outer periphery thereof, which is provided for charging the battery.

8. The fire extinguisher apparatus as claimed in claim 1, wherein every adjacent two of the protrusions of the striking portion are spaced apart to define a recess therebetween such that the striking portion of the head is substantially crown-shaped.

9. The fire extinguisher apparatus as claimed in claim 1, wherein the shank of the lighting device is applied on a surface thereof with fluorescence materials.
